(19) United States
(12) Patent Application Publication
(10) Pub. No.: US 2001/0049263 A1
(43) Pub. Date: Dec. 6, 2001

(54) AUTOMATIC STATION/SYSTEM CONFIGURATION MONITORING AND ERROR TRACKING SYSTEM AND SOFTWARE UPGRADE TOOL KIT

(76) Inventor: XIANG ZHANG, SAN DIEGO, CA (US)

Correspondence Address: FROMMER LAWRENCE & HAUG, 745 FIFTH AVENUE- 10TH FL., NEW YORK, NY, 10151, US

(21) Appl. No.: 09/048,742

(22) Filed: Mar. 26, 1998

(51) Int. Cl. H04B 17/00

(52) U.S. Cl. 455/67.1; 455/418; 455/419; 455/423; 455/425

(57) ABSTRACT

A mobile station monitoring system is provided in accordance with the invention. The mobile station monitoring system includes a maintenance task module which accumulates performance data reported within a mobile station, a transmission conduit for transmitting accumulated performance data to a central location, and a central receiver at the central location which receives and deciphers the transmitted accumulated performance data. The invention also includes a mobile station having a maintenance task module which accumulates performance data reported within the mobile station, and a transmission conduit for transmitting accumulated performance data to a central receiver. In accordance with the invention, a method for monitoring a mobile station is also provided. The method includes the steps of accumulating performance data reported within a mobile station, transmitting accumulated performance data to a central location, and receiving and deciphering the transmitted accumulated performance data.

### BACKGROUND OF THE INVENTION

This invention relates generally to a monitoring and software control and upgrade system for a mobile station, and more particularly, to a specific apparatus and method designed to allow for the monitoring and tracking of cellular system performance. Information regarding performance or errors may be transmitted to a central station, thereby allowing for slight configuration changes to be made via the cellular network, or alerting for the need for a more extensive software upgrade. Upon the upgrading of software, the results of this upgrade can then be further monitored to insure that the upgrade software has been properly installed, and that the software is curing my previously existing defects.

Mobile stations, such as cellular telephones and portable computers, as well as all forms of telephone/data storage devices are becoming very popular. Indeed, this great proliferation of mobile station devices has resulted in an overcrowding of the system resources of the service providers in this field. Thus, the service providers have been required to upgrade the capabilities of their system, often incorporating new hardware and new software for the job. However, when upgrading this material, it is necessary to make all software and hardware changes downwardly compatible so that the system may accommodate any older mobile station units which may be in use by its customers. This requirement of downward compatibility has severely limited the upgrade capability of the service provider systems.

One way to overcome this problem is to upgrade the software contained within a user's mobile station unit. However, this upgrade is very time-consuming and expensive for the service provider. It is currently necessary for each user to bring his or her mobile station unit to a representative of the service provider who may either be able to upgrade the mobile station's software on site, or may even be required to send the unit back to the service provider or the producer of the unit to perform the upgrade. Clearly, this is an inefficient, time consuming and expensive method for upgrading software and/or hardware within a mobile station, or service provider's station.

Additionally, in order to determine whether such a software upgrade is necessary, both service providers and mobile station manufacturers must receive performance and/or error information regarding the individual mobile station units, as well as the interaction of these mobile station units with the service provider software, data transmission equipment, and routing equipment. However, at this time, such error information and performance data may only be provided to a service provider or a mobile station producer if a diagnostic program is run on the mobile station when the mobile station is brought into a service provider or a mobile station producer. Additionally, errors may be reported to a service provider, or mobile station producer when encountered by users, or when complaints are lodged. However, neither of these systems is foolproof since errors reported by a user are often reported inaccurately and do not give enough data to the service provider or mobile station producer in order to confirm what the actual problem is. Additionally the problem cannot be properly monitored in order to allow it to be fixed. Additionally, upon the implementation of new software within a mobile station, or service provider's station, if errors exist, the reporting techniques noted above may not indicate the particular portions of code or programming which are operating improperly. Therefore, it may be very difficult to analyze such software and to provide an error-free use to a user.

### OBJECTS OF THE INVENTION

Accordingly, it is an object of the invention to provide an improved mobile station which overcomes the drawbacks of the systems currently in use.

Another object of the invention is to provide an improved automatic mobile station system/performance monitoring and error reporting system which allows for the remote tracking of performance and errors of a mobile station.

A further object of the invention is to provide an improved automatic mobile station system/performance monitoring and error reporting apparatus and method which allow for a service provider, or a mobile station producer to receive automatic reports regarding performance and error data from a mobile station, without any intervention by a user.

Yet another object of the invention is to provide an improved automatic mobile station system/performance monitoring and error reporting system and method which allow for certain parameters of the system to be automatically changed as necessary by the service provider or mobile station producer.

A still further object of the invention is to provide an improved upgrade kit for automatically upgrading software contained within a mobile station.

Yet a further object of the invention is to provide an improved upgrade kit for upgrading software within a mobile station which further allows for performance and error data as a result of the upgrade software to be automatically transmitted to a service provider, or mobile station producer without any intervention by a user.

Still another object of the invention is to provide an improved upgrade kit which may interact with a mobile station, upgrading the software therein, and allowing for the automatic reporting of performance and error data therefrom, which in turn allows for the automatic alteration of certain parameters in the software in order to enhance performance thereof.

Still other objects and advantages of the invention will in part be obvious and will in part be apparent from the specification and the drawings.

### SUMMARY OF THE INVENTION

Generally speaking, in accordance with the invention, an automatic mobile station system/performance monitoring and error reporting system and method is provided for sampling and automatically recording error and performance data of a mobile station. During the use of the mobile station by a user, internal error messages and performance red data are stored in a non-volatile memory which allows this material to be stored even if the mobile station is powered down. After either a predetermined amount of time has passed, a predetermined number of errors have occurred and been accumulated, or a particular fatal error has occurred, this material may be transmitted to the service provider for use thereby or by the product manufacturer. This material may be transmitted when a mobile unit has been powered up, but is currently in the idle mode and is not transmitting other information. Additionally, this material may be transmitted along with an additional data signal, in any unused portion of the signal. Advantageously, the data is encrypted so as not to interfere with the data transmission. The data is preferably transmitted a number of times in succession in case any errors occur during transmission.

Upon receipt of the performance and error information, a computer may be provided at the service provider to analyze this material, or to retransmit this material to the mobile station producer. Any other features and/or software elements of the mobile station may be monitored as desired by the service provider and/or station manufacturer. Upon receipt of the performance and error data from any number of users, a system provider, or product manufacturer may track the success and/or failure of a particular software upgrade or a particular new product which is being used by certain users. Therefore, error feedback and performance feedback will be provided so that any adjustments which are necessary may be made.

Also in accordance with the invention, upon analysis of these error and performance data, instructions may be transmitted to each of a certain class of mobile stations in order to adjust the parameters of the software contained therein in order to improve performance or overcome any errors which may be occurring. Therefore, even certain users who did not complain of particular errors will have their software parameters adjusted, since the adjustment takes place by way of a broadcast to all users. Additionally, the software changes may be transmitted to each user upon the placing of a call or the turning on of his unit. Thus, certain parameter and software changes may be made by broadcast to all users of a particular service, or all users of a particular product, even without the knowledge of the user so that performance may be optimized.

Upon review of certain error and/or performance data, or with the requirement of certain system upgrades, it may become necessary to provide users and owners of a particular mobile station a software upgrade which includes more information than may be readily transmitted as a broadcast. In this case, in accordance with the invention, an upgrade unit is provided to each user in order to upgrade the software within the mobile station. Specifically, in accordance with the invention, a small unit, which is preferably the size of a credit card or smaller, is provided which includes a non-volatile memory including all instructions and data for the required software upgrade. This card is simply attached to a data port of the mobile station by a user, and the mobile station is powered up. Instructions contained within the upgrade kit then automatically upgrade the software in the mobile unit in accordance with the instructions and data thereon.

After completion of the software upgrade, the confirmation of the software upgrade may be transmitted as before, that is, as performance data of the unit. Thereafter, as noted above, the performance and error characteristics of the upgraded software may be monitored, in order to insure that they are operating properly, and in order to further allow for the manipulation of various parameters as necessary in order to streamline and guarantee optimum performance of the software and hardware. The software upgrade kit may be provided at extremely low cost, the power for running the kit being provided by the mobile system when the software upgrade kit is plugged into the data port thereof.

The invention accordingly comprises the several steps and the relation of one or more such steps with respect to each of the others, and the apparatus embodying features of the construction, combinations of elements and arrangement of parts which are adapted to effect such steps, all exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a diagram illustrating the automatic transmission of performance and error data from each of a mobile station to a central service center;

FIG. 2 is a diagram illustrating the transmission of configuration information from a service center to each of a number of mobile stations;

FIG. 3 is a flow diagram illustrating the flow of information between different modules of a mobile station; and

FIG. 4 is a block diagram illustrating the construction of a software upgrade kit constructed in accordance with the invention.

### DETAILED DESCRIPTION OF THE PREFERRED EMBODIMENTS

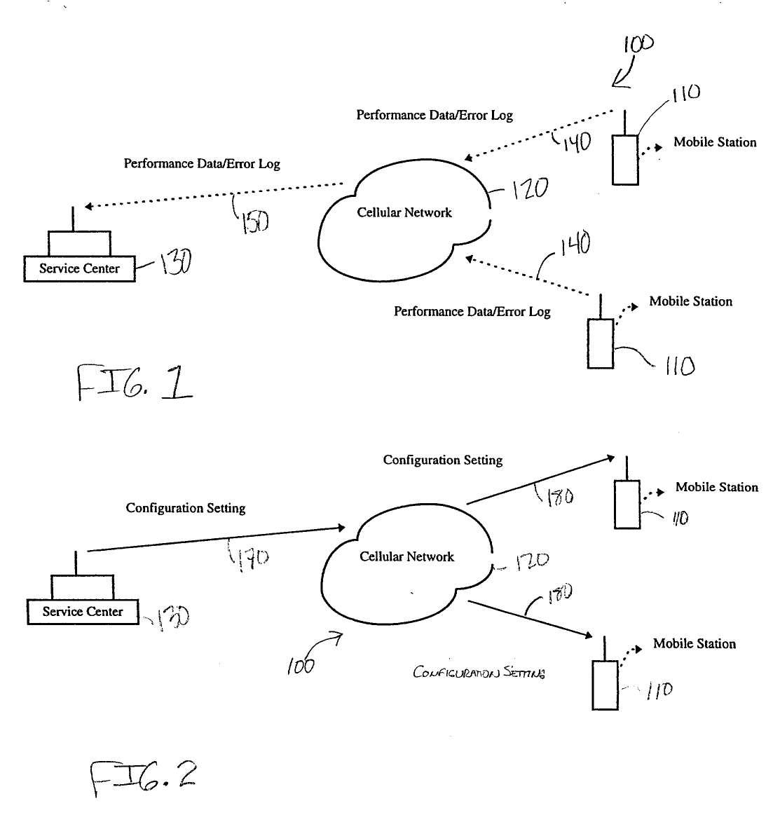

Reference is first made to FIG. 1 which depicts the performance and error data automatic reporting system, indicated generally at 100. Performance and error data system 100 further comprises a plurality of mobile stations 110, a cellular network 120 and a service center, or base of operations of the service provider 130. Performance and error data system 100 further comprises transmission signals 140 for transmitting various information between each mobile station 110 and cellular network 120, and transmission signal 150 for transmitting information between cellular network 120 and service center 130. As is shown in FIG. 1, performance and error data are accumulated in each mobile station 110 (as will be discussed below). This information is transmitted at the appropriate time via transmission signals 140 to a cellular network 120, which acts as a conduit for the information. Upon recognition by cellular network 120 that the information transmitted over transmission signals 140 comprises performance and error data, cellular network 120 transmits this information via transmission signal 150 to the service center, or home base of the service provider 130. Service center 130 recognizes the performance and error data from transmission signal 150, and extracts this information for further processing. Thus, performance and error data is transmitted from each mobile station 110, and is accumulated for processing at service center 130.

During use, the invention employs a cellular data protocol, including but not limited to Data Burst Message protocol for CDMA. The invention may be applied to any cellular communication using the CDMA protocol including lS-95, IS-95A, JSTD-008, TDMA, including IS-54B, IS-136, and GSM protocol standards. The implementation of the invention requires the inclusion of initial software for monitoring of the performance and error data at service center 130, and additional software to maintain performance and error data logs at each mobile station 100. The inclusion of this additional software at each mobile station 100 will be explained below.

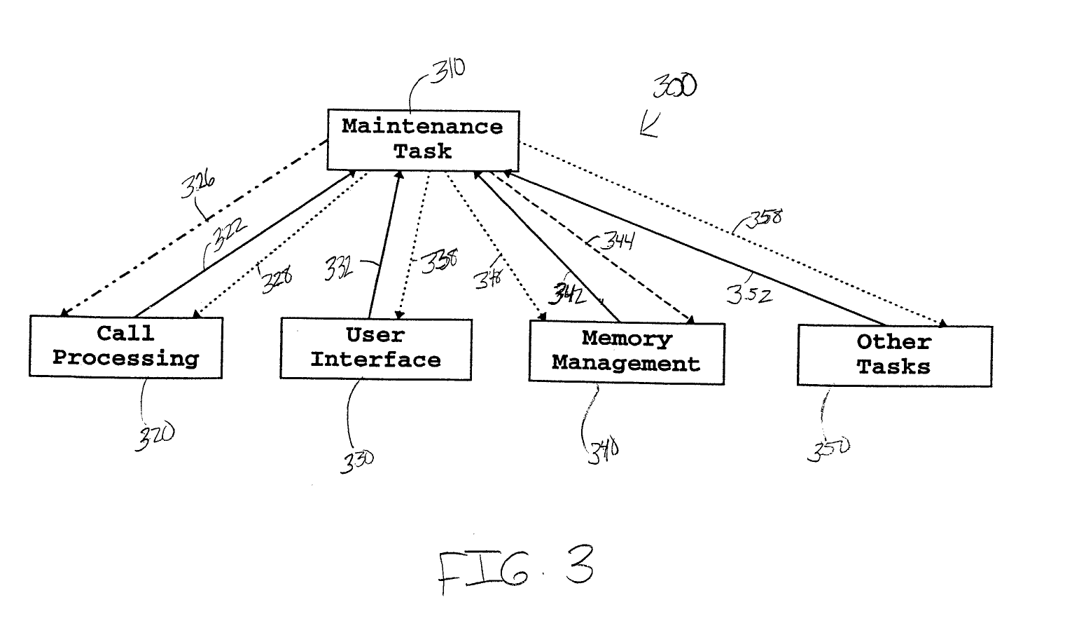

Referring next to FIG. 2, performance and error data system 100 is depicted operating in a second mode, in which various configuration setting data is provided to each mobile station 110. Specifically, after service center 130 has compiled all of the performance and error data which was received in FIG. 1, the material is processed and various trends and other information may be obtained through this analysis. Based on this analysis, it may be necessary to either modify certain parameters of the software of each of the mobile stations in order to improve the performance and reduce errors. It may also be necessary to modify the performance and data logs being kept by mobile stations 110 in order to monitor different aspects and different features of the operation of each mobile station 110. Therefore, in accordance with these required modifications to the software of each mobile station 110, instructions in order to incorporate these changes are first transmitted from service center 130 to cellular network 120 via a transmission signal 170.

After receipt of the information by cellular network 120, this information is transmitted to each mobile station 110 via a plurality of individual transmission signals 180. Transmission signals 180 may be implemented in at least one of two ways. First, it is possible to generate a general broadcast to all mobile stations 100 for transmitting the required information thereto. This would be appropriate only if the information applied to all different types of mobile station units. However, this may not be the case. If it is necessary to update software for only one, or any particular number of mobile stations, or for only particular types of mobile stations, it would also be possible to transmit a broadcast to all mobile stations 110, and include an instruction that only certain mobile stations 110 incorporate the software modifications.

While this transmitted information will be received by a large number of mobile stations 110, it is possible that any number of additional mobile stations 110 which were to receive the transmission may be turned off during the transmission, and will therefore not be receiving information when the transmission is made. Therefore, in accordance with the invention, each mobile station may confirm whether it has received a specific software parameter change or not upon the powering up of the mobile station. Thus, this would insure that upon powering up of each mobile station 110, if the required configuration information has not been received, it will be downloaded at that point. Obviously, it would be most efficient to employ a dual system, in which a general broadcast were made for a predetermined period of time, and thereafter information was transmitted specifically to each mobile station 110 which had not previously received the information from the broadcast.

Either the performance and error data log transmission from each mobile station 100 to service center 130 depicted in FIG. 1, or the configuration setting transmission from service center 130 to each mobile station 110 may be implemented using Data Burst Messages, or any other appropriate transmission system. Additionally, it is preferred that the message contents be encrypted to insure that only certain appropriate mobile stations 110 receive the configuration setting the information as necessary.

Additionally, in accordance with the invention, information may be transmitted from each mobile station 110 to service center 130 while in the idle, or traffic modes only. Thus, while awaiting an incoming phone call or during a traffic mode, when additional bandwidth is available in the transmission signal, the performance and error data logs may be transmitted from each mobile station 110. Thus, it is not necessary for a user to power up the system and initiate a data sequence for transmission of this information. Additionally, transmission of this information will be invisible to the user, and system performance will not be impaired. Thus, since the reporting and upgrading of the system is invisible to a user, it can be implemented more frequently to transmit more information. Thus, and more complete results will be received by the service center than in any previous apparatus or method employed for this purpose.

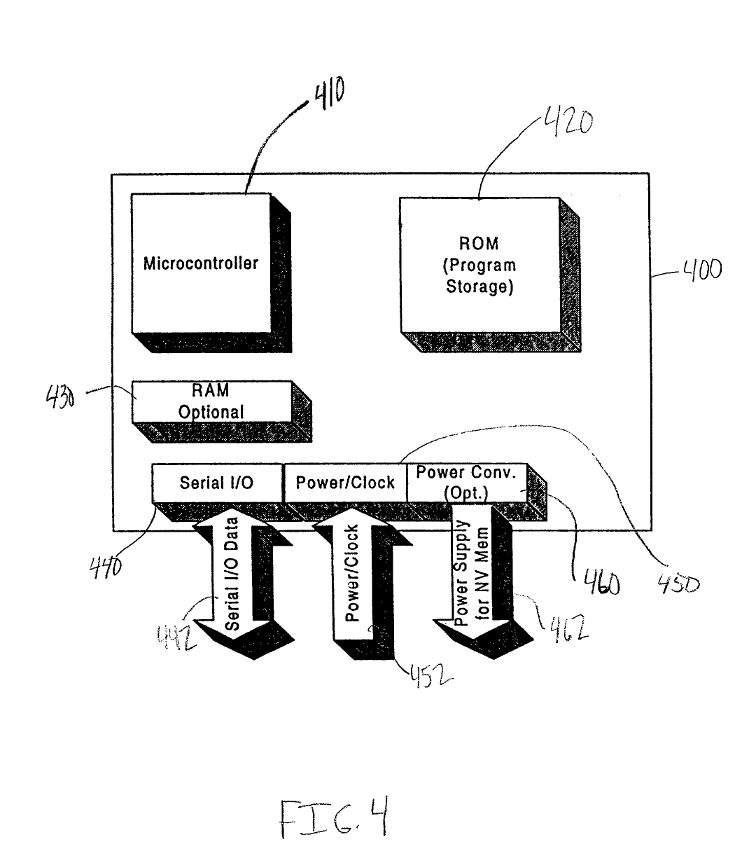

Reference is next made to FIG. 3 which depicts a relationship between various modules contained within each individual mobile station 110. As is shown in FIG. 3, a general structure relationship between the different modules, is indicated generally at 300. The modules comprise a maintenance task 310, which acts as an overall operation management module for each of the other modules in the system when the mobile station is in maintenance mode. Module system 300 further comprises a call processing module 320 for processing incoming and outgoing calls, a user interface 330 which receives and displays information to a user, a memory management module 340, which stores various non-volatile information inputted by the user, various software information required and inputted by a service provider and/or mobile station manufacturer, and is additionally utilized to maintain performance and error data logs. An other task module 350 for performing any additional tasks required by mobile station 110 is also provided. The relationship depicted between each of these modules is shown only for implementation of the collection, transmission and receipt of performance and error data logs and configuration setting information. It should be apparent that these modules are also utilized for other features, such as, when an outgoing call is placed, the user interface must be utilized to gain the number which is to be dialed, and the memory management module must be utilized to provide various encryption and other stored programming in order to process the call.

The relationship between the various modules of module system 300, and the operation, transmission and receipt of performance and error data logs and configuration setting information will now be described.

During use, each module 320, 330, 340 and 350 contains software which allows it to recognize any errors generated within their specific processing. These errors are transmitted from each module 320, 330, 340 and 350 to maintenance task module 310 along transmission signals 322, 332, 342 and 352, respectively. For example, call processing module 320 might indicate that a call was dropped, and might indicate the reason for this call drop along transmission signal 322. Similarly, user interface 330 might indicate that a particular portion of an LED display, or various of the numbers or characters on the face of mobile station 110 are not operating properly and may transmit this information via signal 332. Furthermore, memory management module 340 might recognize a memory storage error, indicating that certain portions of the software within the system may be lost, or certain user defined settings may have been reset, and transmit this error information on signal 342. Finally, any errors in the other tasks may be reported by other tasks module 350 to maintenance task module 310 via signal 352. Thus, as various errors occur, these errors are reported to maintenance task module 310.

In a preferred embodiment the error information which is reported to maintenance task module 310 includes at least software and hardware version, an indication that an error occurred, the task and procedure name in which the error occurred, and a particular error description, among any other required information. Additionally, the performance data may include a record of the performance of various system resources, statistics information regarding the number of calls such as the number of call drops, call completions and other information, and statistical information from the modem, in addition to any other information. Furthermore, the report of an upgraded software version implementation may also be compiled and transmitted as performance data. A matrix of switches may also be created for each task and for each error and performance category, thereby allowing improved implementation of the invention. Finally, in a preferred embodiment, from 50 to 500 bytes of non-volatile memory, or EEPROM memory are provided within memory management module 340 in order to store the error and performance information if power is turned off at mobile station 110.

Maintenance task module 310 analyzes each of these errors to determine if they are errors which have been previously reported or if they are new errors and the importance of the errors. After processing this information, required information regarding these errors are transmitted to memory management module 340 via signal 344. Thus, memory management module 340 maintains the appropriate performance and error data logs, preferably compiling the number of times a particular error has occurred, the types of errors which have occurred, and any other performance data required by the system.

Thus, the error logs might include features such as handling and recognizing all messages of system performance data and error data received from any of the task modules. At least the five most frequently occurring errors are preferably maintained in the error log, and if out of space, and transmission is not yet possible, a less frequently occurring error may be deleted from the log. Additionally, at least five types of performance data information should be able to be compiled at one time.

During use, maintenance task module 310 monitors these performance and error data logs contained in memory management module 340 in order to determine when this information should be transmitted to service center 130 (FIG. 1). The criteria for transmission may be varied, including a predetermined amount of time having elapsed prior to the last performance and data log transmission, or receipt of a broadcast signal from service center 130 indicating that the information should be transmitted. Other actions which may result in the transmission of this information may be the compiling of more than a predetermined number of errors within memory management module 340, or the recognition of a particularly important, dangerous, or fatal error recognized by maintenance task module 310.

Once it is determined that the performance and error data logs are to be transmitted from a particular mobile station 110 to service center 130, maintenance task module 310 retrieves the processing and error data information from memory management module 340, processes and encrypts this information in order to prepare it for transmission, and notifies call processing module 320 that the information is ready to be transmitted.

Thereafter, call processing module 320 monitors the system to determine the current state in which the system is operating, and informs maintenance tasks 310 whether this state is one in which the performance and error data log information may be transmitted. Specifically, the information is preferably transferred during an idle time or during a traffic time. Thus, transmission of the information may take place during a traffic time without interrupting other data being transmitted, or during an idle time in which the mobile station 110 is simply awaiting an incoming transmission or further instructions from the user. If maintenance task module 310 notifies call processing task module 320 that it is necessary to transmit a performance and error data log, and call processing module 320 has confirmed that mobile station 110 is in a proper state in which to transmit this information, call processing unit 320 transmits this information, as provided by maintenance task module 310. In a preferred embodiment, the information is transmitted at least more than once, so that it can be insured that the information is properly received.

Alternatively, it would also be possible for an attachment of a further mechanism (not shown) to a data port of mobile station 110, which would immediately allow for the downloading of the information by maintenance task module 310, therefore not requiring transmission of this information over the cellular network. This procedure would be beneficial if mobile station 110 were brought to a service provider, or mobile station manufacturer for service, and it was necessary to determine the current status of any errors within mobile station 110.

Thus, call processing module 310 transmits information from mobile station 110 along transmission signal 140, as is shown in FIG. 1. This information is then received by service center 130 for processing.

Service center 130 is preferably designed to decrypt the encrypted transmitted information, and should be able to interpret all of the performance data and error data which was transmitted, and process the same. Additionally, after this information has been analyzed, if any configuration changes are necessary, it would then be possible for service center 130 to transmit these instructions to modify the parameters or other settings within each mobile station 110. Thus, if it is determined that parameter changes or the like are required, these configuration settings are generated, encrypted and transmitted from service center 130 along transmission signal 170 (FIG. 2). This encrypted information is received by each mobile station 110 via transmission signal 180. The information is thus forwarded to call processing module 320, which recognizes the information as configuration setting information, and transmits this configuration setting information to maintenance task module 310 via transmission signal 322. Maintenance task module 310 decrypts the information, recognizes the particular commands which have been transmitted, and instructs the appropriate modules 320, 330, 340 or 350 of this configuration setting information via transmission signals 328, 338, 348 and 358, respectively. In this manner, configuration setting information transmitted from service center 130, and decoded and decrypted by maintenance task module 310 can be used to modify any individual parameters or other settings required in each of the modules of mobile station 110.

Since the data being transmitted is of a standard type, no changes in cellular network 120 are required for implementation of the invention. Only a new, specific type of message will be added at both ends of the system.

While the previous description indicates the retransmission of various configuration setting information when small changes in parameters and other settings are required at one or more mobile stations 110, it is possible that upon analysis of the performance and error data logs received by service center 130, it is determined that either a fatal error, or other problem has occurred which requires loading of entirely new software into mobile station 110. Additionally, in order to incorporate additional operative features on a system wide basis in order to upgrade a complete cellular system, it may be necessary for service center 130 to upgrade a large portion of the software in all mobile stations 110. Since the transmission of this large amount of information may not be efficiently provided over the network, it may be necessary to provide each user with an easy upgrade apparatus for upgrading the software.

For this purpose, reference is next made to FIG. 4, which depicts a software upgrade kit 400 constructed in accordance with the invention. It also can be a stand alone application for any type of remote software upgrade.

Software upgrade kit 400 may be formed as a smart card, or the like, and includes a microcontroller 410, a read-only memory module 420 for program storage, an optional RAM memory module 430, a serial input/output module 440, a power and clock input module 450 and an optional power conversion output module 460. Serial input/output module 440 is further formed with a serial input/output data transmission signal 442, power and clock module 450 receives a power and clock signal from an external source via input signal 452, and optional power converter 460 provides a power supply for various non-volatile memory via an output signal 462. Microcontroller 410 is configured to implement only the software upgrade feature, and is not useful for any further operation. The software upgrade instructions, including required data and operating instructions are contained within ROM module 420. ROM module 420 may be employed to hold, by way of example, a specific model number of the specific mobile station 110 which upgrade kit 400 is applicable to. Therefore, by use of this stored electronic serial number, it would be possible to insure that this upgrade kit 400 were not accidentally used with any other mobile station 110, other than the anticipated mobile station 110. While this is not necessarily as important when general software upgrades are provided, this may be important if a software upgrade is provided to only a particular user in order to remedy a particular problem. Additionally, if a software upgrade is an enhancement which must be paid for by a user, it can be insured that this upgrade is not used to upgrade software or any unauthorized phones for which the upgrade was not purchased. Thus, through the use of such an upgrade system 400, all required upgrade programming information can be provided to a user on a small card, and the user is not required to bring the mobile station 110 to a service provider or mobile station producer for upgrade.

Operation of software upgrade tool kit 400 will now be described.

Upon receipt of a mobile station upgrade kit 400, the user will be instructed to power down mobile station 110, and engage mobile station software upgrade kit 400 with mobile station 110 by coupling a portion of software kit 400 containing serial I/O mode 440, power clock module 450 and power converter module 460 with a data port of mobile station 110 (not shown). After mobile station upgrade kit 400 is inserted into the data port of mobile station 110, the user powers up mobile station 110. This powering up of mobile station 110 provides power to mobile station upgrade unit 400 via transmission line 452, thus providing power and a clock signal to power and clock module 450. Mobile station 110 will automatically recognize mobile station upgrade kit 400, and will then automatically enter an upgrade mode. Upon receiving power and a clock signal at power and clock module 450, mobile station upgrade kit 400 is powered up, and microcontroller 410 takes over control of the upgrade procedure.

Microcontroller 410 obtains the required programming instructions and data from ROM storage module 420, and implements the instructions by inputting and outputting the appropriate data through serial I/O module 440, which transmits this data over serial input/output transmission signal 442. This transmission signal 442, and serial input/output module 440 instructs and controls the upgrading of the software within mobile station 110, and receives information from mobile station 110 regarding completion, error correction, and the status of the upgrading procedure. Since a simple protocol is utilized for upgrade communication, expensive connection machinery is not required. While the upgrading is taking place, a user interface employed in mobile station 110 notifies the user of the status of the upgrade, i.e., that the upgrade is proceeding and/or the percentage of the upgrade which has been completed, and when complete, that the upgrade has been completed.

A protocol which may be used is a software upgrade code, which may be specifically designed for use to upgrade software to such a mobile station. In a preferred embodiment, ROM module 420 may be provided with one megabyte of memory or less, but more may be utilized if necessary.

As noted above, an electric mobile station upgrade kit 400 may be instructed to check for a particular electronic serial number of mobile station 110, thereby insuring that the upgrade program is only employed on the proper mobile station 110. This electronic serial number confirmation software may be employed in ROM module 420, and the electronic serial number stored in ROM module 420 as well.

Thus, through the use of such a mobile station upgrade kit 400, it is possible to forward such a kit to each user, have the user connect the received kit 400 to their mobile station 110, and have the software version of their mobile station automatically upgraded. After being upgraded, it would be possible to utilize the system depicted in FIGS. 1-3 in order for mobile station 110 to report to service center 130 that the upgrade has been completed, and also for service center 130 to check the performance and integrity of the upgraded software to confirm that it is operating properly. Then, as noted above, it would be possible to adjust parameters and various other features of the software if necessary. Additionally, if the software upgrade failed, it would be possible to send an additional upgrade kit 400 to a user to reupgrade the software, if necessary.

Since the components employed in such an upgrade kit are very inexpensive, because only a small amount of microprocessor power and ROM and RAM storage are required, in a preferred embodiment, the tool kit can be priced very inexpensively, possibly below $4.00. Furthermore, because of its inexpensive price, it would be possible for a user to discard the upgrade kit after use. Additionally, as noted above, since an electronic serial number checking mechanism may be employed, it would not be possible for the upgrade kit to be utilized with an improper mobile station 110. Finally, since the programming information in the upgrading kit is compressed, less space is necessary. The decompression of the information may either be performed by mobile station 110, or microcontroller 410 of upgrade kit 400. Thus, through the use of such an upgrade kit 400, software may be upgraded, problems discovered in older software may be cured, new features may be added, various internal coding of mobile station 110 may be changed and any other necessary information may be provided.

Therefore, in accordance with the invention, it is possible to provide a fully automatic monitoring system of software of a mobile station 110, and whereby it is possible to automatically adjust various parameters and settings within mobile station 110 without the user being aware of these changes. Additionally, if more extensive software upgrades are required, these upgrades can be made by use of an automatic upgrade kit, and the status of mobile station 110 after the upgrades have been made can be remotely monitored with no further intervention by the user.

It will thus be seen that the objects set forth above, among those made apparent from the preceding description, are efficiently attained and certain changes may be made in carrying out the above method and in the construction set forth without departing from the spirit and scope of the invention. It is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A mobile station monitoring system, comprising:
a maintenance task module which accumulates performance data reported within a mobile station;
a transmission conduit for transmitting said accumulated performance data to a central location; and
a central receiver within said central location which receives and deciphers said transmitted accumulated performance data.

2. The mobile station monitoring system of claim 1, wherein said maintenance task module receives performance data reports from at least one operational module of said mobile station.

3. The mobile station monitoring system of claim 2, further comprising a plurality of operational modules, including at least:
a call processing module;
a user interface; and
a memory management module.

4. The mobile station monitoring system of claim 2, wherein said maintenance task module stores said performance data reports in a memory management module.

5. The mobile station monitoring system of claim 2, wherein said maintenance task module determines if a predetermined condition has been met, and if so transmits said performance data reports.

6. The mobile station monitoring system of claim 5, wherein said predetermined condition includes a predetermined time limit having elapsed since a previous transmission of said performance data reports.

7. The mobile station monitoring system of claim 5, wherein said performance data includes at least one error message.

8. The mobile station monitoring system of claim 7, wherein said predetermined condition includes the recognition of at least one of a predetermined number of error messages.

9. The mobile station monitoring system of claim 7, wherein said predetermined system includes the accumulation of at least a predetermined number of error messages.

10. The mobile station monitoring system of claim 1, wherein said central receiver evaluates said deciphered transmitted accumulated errors and transmits correctional information to said mobile station, if necessary.

11. The mobile station monitoring system of claim 10, wherein said correctional information includes at least modified parameters for use by said mobile station.

12. The mobile station monitoring system of claim 10, further comprising a software upgrade kit for use to upgrade software within said mobile station if it is determined by said central receiver that the transmission of correctional information will not be sufficient to correct mobile station errors.

13. The mobile station monitoring system of claim 12, wherein said performance data includes at least information regarding the functioning of a software upgrade implemented by said software upgrade kit.

14. A mobile station, comprising:
a maintenance task module which accumulates performance data reported within said mobile station; and
a transmission conduit for transmitting said accumulated performance data to a central receiver.

15. The mobile station of claim 14, wherein said maintenance task module receives performance data reports from at least one operational module of said mobile station.

16. The mobile station of claim 15, wherein said maintenance task module stores said performance data reports in a memory management module.

17. The mobile station of claim 15, wherein said maintenance task module determines if a predetermined condition has been met, and if so transmits said performance data reports.

18. The mobile station of claim 14, further comprising a receiving conduit for receiving correctional information.

19. The mobile station of claim 18, wherein said correctional information includes commands altering at least parameters maintained within said mobile station.

20. The mobile station of claim 14, wherein said performance data includes at least one error message.

21. The mobile station of claim 14, wherein said performance data includes at least information regarding the functioning of a software upgrade implemented by a software upgrade kit.

22. A mobile station monitoring system, comprising:
accumulation means for accumulating performance data reported within a mobile station; and
transmission means for transmitting said accumulated performance data to a central receiving means, said central receiving means adapted to receive and decipher said transmitted accumulated performance data.

23. The mobile station monitoring system of claim 22, wherein said accumulation means receives performance data reports from at least one module of said mobile station.

24. The mobile station monitoring system of claim 23, further comprising at least:
call processing means;
user interface means; and
memory management means.

25. The mobile station monitoring system of claim 23, wherein said accumulation means stores said performance data reports in memory management means.

26. The mobile station monitoring system of claim 23, wherein said accumulation means determines if a predetermined condition has been met, and if so transmits said performance data reports.

27. The mobile station monitoring system of claim 22, wherein said performance data includes at least one error report.

28. The mobile station monitoring system of claim 22, wherein said central receiving means evaluates said deciphered transmitted accumulated performance data and transmits correctional information to said mobile station if necessary.

29. The mobile station monitoring system of claim 28, wherein said correctional information includes at least modified parameters for use by said mobile station.

30. The mobile station monitoring system of claim 28, further comprising software upgrade means for use to upgrade software within said mobile station if it is determined by said central receiving means that the transmission of correctional information will not be sufficient to correct mobile station errors.

31. The mobile station monitoring system of claim 30, wherein said performance data includes at least information regarding the functioning of a software upgrade implemented by said software upgrade means.

32. A mobile station, comprising:
accumulation means for accumulating performance data reported within said mobile station; and
transmission means for transmitting said accumulated performance data to a central receiving means.

33. The mobile station of claim 32, wherein said accumulation means receives performance data reports from at least one operational module of said mobile station.

34. The mobile station of claim 33, wherein said accumulation means stores said performance data reports in a memory management module.

35. The mobile station of claim 33, wherein said accumulation means determines if a predetermined condition has been met, and if so transmits said performance data reports.

36. The mobile station of claim 32, further comprising receiving means for receiving correctional information.

37. The mobile station of claim 36, wherein said correctional information includes commands altering at least parameters maintained within said mobile station.

38. The mobile station of claim 32, wherein said performance data includes at least error data.

39. The mobile station of claim 32, wherein said performance data includes at least information regarding the functioning of a software upgrade implemented by software upgrade means.

40. A method for monitoring a mobile station, comprising the steps of:
accumulating performance data reported within a mobile station;
transmitting said accumulated performance data to a central location; and
receiving and deciphering said transmitted accumulated performance data.

41. The method of claim 40, further comprising the step of receiving performance data reports from at least one operational module of said mobile station.

42. The method of claim 41, further comprising the step of storing said performance data reports in a memory management module.

43. The method of claim 42, further comprising the step of determining if a predetermined condition has been met, and if so transmitting said performance data reports.

44. The method of claim 43, wherein determining if said predetermined condition has been met includes the step of determining whether a predetermined time limit has elapsed since a previous transmission of said performance data reports.

45. The method of claim 43, wherein said performance data includes at least one error message.

46. The method of claim 45, wherein determining if said predetermined condition has been met includes the step of determining whether at least one of a predetermined number of error messages has been recognized.

47. The method of claim 45, wherein determining if said predetermined condition has been met includes the step of determining whether at least a predetermined number of error messages have accumulated.

48. The method of claim 40, further comprising the steps of:
evaluating said transmitted accumulated performance data;
determining whether correctional information is necessary; and
transmitting correctional information to said mobile station, if necessary.

49. The method of claim 48, wherein said correctional information includes at least modified parameters for use by said mobile station.

50. The method of claim 48, further comprising the steps of:
determining whether the transmission of correctional information will be sufficient to correct mobile station errors; and
upgrading software within said mobile station by the use of an upgrade kit if it is determined the transmission of correctional information will not be sufficient.

51. The method of claim 50, further comprising the step of transmitting performance data including at least information regarding the functioning of said upgraded software.

52. A method for operating a mobile station, comprising the steps of:
accumulating performance data reported within said mobile station; and
transmitting said accumulated performance data to a central receiver.

53. The method of claim 52, further comprising the step of receiving performance data reports from at least one operational module of said mobile station.

54. The method of claim 53, further comprising the step of storing said performance data reports in a memory management module.

55. The method of claim 53, further comprising the step of determining if a predetermined condition has been met, and if so transmitting said performance data reports.

56. The method of claim 52, further comprising the step of receiving correctional information from a central receiver.

57. The method of claim 56, further comprising the step of altering at least parameters maintained within said mobile station in accordance with said correctional information.

58. The method of claim 52, wherein said performance data includes at least error data.
